(19) United States
(12) Patent Application Publication
(10) Pub. No.: US 2025/0104280 A1
(43) Pub. Date: Mar. 27, 2025

(54) SELF-CONFIGURING SENSOR

(71) Applicant: Crown Equipment Corporation, New Bremen, OH (US)

(72) Inventors: Sebastian Theos, Vaterstetten (DE); Andreas Simon, Munich (DE)

(21) Appl. No.: 18/898,968

(22) Filed: Sep. 27, 2024

Related U.S. Application Data
(60) Provisional application No. 63/585,700, filed on Sep. 27, 2023.

(51) Int. Cl. G06T 7/80

(52) U.S. Cl. CPC G06T 7/80; G06T 2207/30108; G06T 2207/30244; G06T 2207/30252

(57) ABSTRACT

Processes and systems using the processes for configuring a sensor mounted to a vehicle are disclosed. The process starts by determining an orientation of the sensor by collecting a scan from the sensor, determining a field of view of the sensor based on the scan, and deriving an orientation of the sensor on the vehicle relative to the vehicle based on the field of view. After the orientation (including a position on the vehicle) of the sensor is derived, a configuration for the sensor is determined based on the orientation of the sensor with respect to the vehicle and independent of any other sensors that may be present on the vehicle. Then, the sensor is configured based on the orientation of the sensor relative to the vehicle.

### CROSS REFERENCE TO RELATED APPLICATIONS

This application claims the benefit of U.S. Provisional Patent Application Ser. No. 63/585,700, filed Sep. 27, 2023, entitled “SELF-CONFIGURING SENSOR”, the disclosure of which is hereby incorporated by reference.

### FIELD

Various aspects of the present disclosure relate generally to industrial vehicle-mounted sensors and more specifically to self-calibrating, industrial vehicle-mounted sensors.

### BACKGROUND

Industrial vehicles such as materials handling vehicles are commonly used for picking stock in industrial environments (e.g., warehouses and distribution centers). Such vehicles typically include a power unit and a load handling assembly, which may include load carrying forks. The vehicle also has control structures for controlling operation and movement of the vehicle.

In a warehouse or distribution center with autonomous or semi-autonomous vehicles, the vehicles are responsible for transporting goods from one location to another. For example, a vehicle may be required to transport goods from a pickup location to a putaway location. As such, these autonomous or semi-autonomous vehicles include sensors that transmit data to the control structures that control operation and movement of the vehicle.

### BRIEF SUMMARY

According to aspects of the present disclosure, processes and systems using the processes for configuring a sensor mounted to a vehicle are disclosed. The process starts by determining an orientation of the sensor by collecting a scan from the sensor, determining a field of view of the sensor based on the scan, and deriving an orientation of the sensor on the vehicle relative to the vehicle based on the field of view. After the orientation (including a position on the vehicle) of the sensor is derived, a configuration for the sensor is determined based on the orientation of the sensor with respect to the vehicle and independent of any other sensors that may be present on the vehicle. Then, the sensor is configured based on the orientation of the sensor relative to the vehicle.

According to further aspects, the sensor is an optical sensor, and in various embodiments, the optical sensor is a camera.

According to further aspects, deriving the orientation of the sensor on the vehicle relative to the vehicle based on the field of view comprises comparing the field of view to images stored on the vehicle, and deriving the orientation of the sensor on the vehicle based on the comparison.

According to further aspects, comparing the field of view to fields of view stored on the vehicle comprises comparing the field of view to the images stored on the vehicle, and determining which image of the images stored on the vehicle has a highest number of similarities.

According to further aspects, deriving the orientation of the sensor on the vehicle based on the comparison comprises matching an orientation to the image of the images stored on the vehicle that has the highest number of similarities.

According to further aspects, determining a configuration for the sensor comprises determining the configuration of the sensor if the highest number of similarities surpasses a threshold.

According to further aspects, determining a configuration for the sensor comprises determining the configuration for the sensor using a processor on the vehicle.

According to further aspects, determining a configuration for the sensor comprises determining the configuration for the sensor using a processor on a server.

According to further aspects, deriving the orientation of the sensor on the vehicle relative to the vehicle based on the field of view comprises sending the fields of view to a server, where the server includes images of fields of view, and receiving the orientation of the sensor from the server. According to still further aspects, comparing the field of view to fields of view stored on the vehicle comprises comparing the field of view to the images stored on the server, and determining which image of the images stored on the vehicle has a highest number of similarities. According to yet further aspects, deriving the orientation of the sensor on the vehicle based on the comparison comprises matching an orientation to the image of the images stored on the server that has the highest number of similarities.

According to further aspects, deriving the orientation of the sensor on the vehicle relative to the vehicle based on the field of view comprises comparing the field of view to images stored on the sensor, and deriving the orientation of the sensor on the vehicle based on the comparison.

According to further aspects, comparing the field of view to fields of view stored on the vehicle comprises comparing the field of view to the images stored on the sensor, and determining which image of the images stored on the vehicle has a highest number of similarities.

According to further aspects, deriving the orientation of the sensor on the vehicle based on the comparison comprises matching an orientation to the image of the images stored on the sensor that has the highest number of similarities.

### BRIEF DESCRIPTION OF THE SEVERAL VIEWS OF THE DRAWINGS

FIG. 1 is a flow chart illustrating a process for automatically configuring a sensor mounted to a vehicle, according to aspects of the present disclosure;

FIG. 2 is a block diagram of a first system for implementing the process for automatically configuring a sensor mounted to a vehicle, according to aspects of the present disclosure;

FIG. 3 is a block diagram of a second system for implementing the process for automatically configuring a sensor mounted to a vehicle, according to aspects of the present disclosure;

FIG. 4 is a block diagram of a third system for implementing the process for automatically configuring a sensor mounted to a vehicle, according to aspects of the present disclosure;

FIG. 5 is a diagram illustrating processing systems and wireless communication that may be used for implementing the process for automatically configuring a sensor mounted to a vehicle, according to aspects of the present disclosure; and

FIG. 6 is a schematic representation of the computing system including a host computer system, according to various aspects of the present disclosure.

### DETAILED DESCRIPTION

An industrial environment (e.g., warehouse, distribution center, supply yard, loading dock, manufacturing facility, retail space, etc.) includes aisles and locations for stock items accessible via the aisles. A typical industrial environment has autonomous or semi-autonomous industrial vehicles to perform operations within the industrial environment.

These autonomous or semi-autonomous industrial vehicles include sensors (e.g., optical sensors such as cameras, lidar (light detection and ranging) systems, etc.) at various positions/orientations (as used herein, an “orientation” also includes a position on a vehicle) on the industrial vehicle. However, in many cases, the same type of sensors may be employed at multiple positions/orientations on the industrial vehicle. For example, an autonomous vehicle may have a camera on its left side, a camera on its right side, and a camera on its back. As such, the sensors must not only be calibrated as normal (e.g., light sensitivity, determination of variance in pixels, etc.), but they must be configured for their position on the industrial vehicle. For example, in a typical situation, a camera on the right side of the industrial vehicle will be configured differently than a camera on the left side of the industrial vehicle. Thus, if the same type of sensor (e.g., a make and model of a camera system) is used in multiple positions/orientations on an industrial vehicle, then each sensor must have a different configuration and a corresponding number so a maintenance person can mount the correct sensor at the correct spot on the vehicle.

However, according to aspects of the present disclosure, the same sensor may be used on various points and orientations on an industrial vehicle. Once the sensor is installed (e.g., by a mechanic), the sensor detects its orientation on the vehicle by scanning (e.g., scan for lidar, take an image for a camera, etc.) and determining a field of view from the scan to derive the orientation of the sensor on the vehicle. Then, based on the orientation, the sensor is configured.

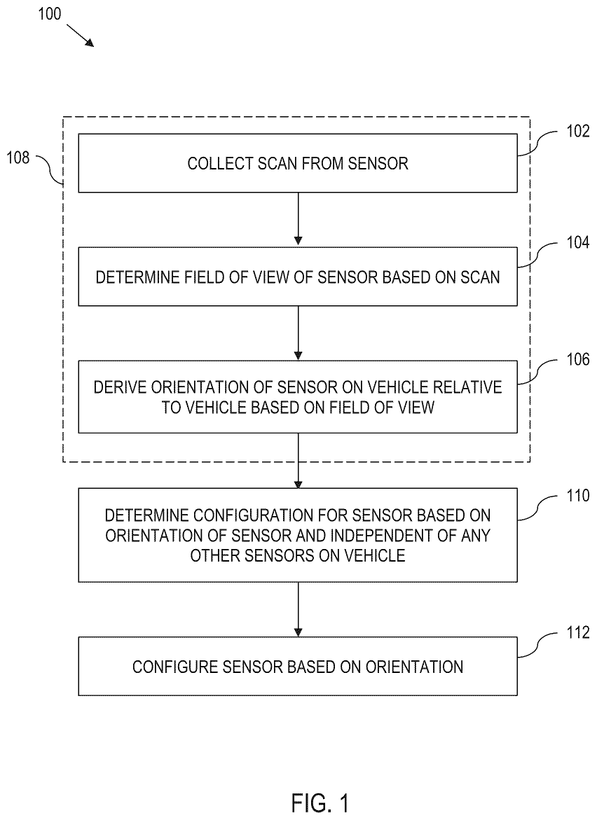

Referring now to the drawings and in particular to FIG. 1, a process 100 for configuring a sensor mounted to a vehicle is shown. At 102, the sensor collects a scan. For example, if the sensor is a camera, then the sensor takes an image or a series of images. As another example, if the sensor is a lidar device, then the sensor may use a laser to emit a beam of light at different angles and measure time of flight (and/or intensity) of reflections to determine distances at those angles. Thus, an “image” may be constructed from the reflections. Other types of sensors may be used, but the common feature is that the sensor that is being calibrated is the same sensor that is collecting the scan.

At 104, a field of view is determined based on the scan. For example, an entire image may be determined as the field of view. In such embodiments, using the entire image of the scan as the field of view is not skipping this step, because it was determined that the entire image of the scan is the field of view. As another example, the image may be cropped or in some way reduced to only important areas of the image of the scan.

At 106, an orientation of the sensor on the vehicle relative to the vehicle is derived based on the field of view. For example, reference images of what a field of view of a camera looks like when the camera is placed on a vehicle in different orientations are stored in memory (e.g., memory of the sensor, the vehicle, a server, etc.). A processor compares the field of view (derived from the scan) to the reference images to determine which of the reference images is closest to the field of view. Then, the processor determines the reference image with a highest number of similarities to the field of view to be associated with a current orientation of the sensor on the vehicle. In some embodiments, the number of similarities must pass a predetermined threshold to be considered the correct reference image. For example, if comparisons of the field of view to all reference images yields similarities of 20%, 30%, 27% and 40%, and the threshold is 85%, then none of the reference images are associated with the orientation of the sensor on the vehicle. The reference images may be fields of view found when placing a sensor on a typical vehicle in an orientation corresponding to the reference image.

At 108, the steps listed above 102, 104, 106 are used to determine the orientation of the sensor on the vehicle. Thus, each reference image is associated with an orientation of the sensor on the vehicle. The processor then determines which orientation is associated with the reference image with the highest number of similarities and uses that orientation as the orientation of the sensor on the vehicle.

At 110, a configuration for the sensor is determined based on the orientation of the sensor on the vehicle. For example, if there are four different orientations that the sensor could be on the vehicle, then there may be four different configuration files stored (one associated with each orientation). As another example, if the sensor may be placed on a first vehicle in four different orientations or a second vehicle with three different orientations, then there may be seven different configuration files stored. Note that the determination of the configuration (and the orientation of the sensor itself) is performed independently of any other sensors found on the vehicle.

At 112, the sensor is configured based on the orientation of the sensor relative to the vehicle. Thus, a configuration file corresponding to the configuration determined at 110 is used to configure the sensor. The configuration file may be located on the sensor, on the vehicle, on a server, or combinations thereof.

### Example 1—Sensor

As an example of the process 100 of FIG. 1, there is an autonomous industrial vehicle with forks for carrying a load, and the vehicle has four locations for placing cameras that are used for autonomous guidance: front, rear, left, and right. Further, there are four reference images that include the following portions, where each image corresponds to a location/orientation: (1) a front reference image includes a rounded portion of the front of the vehicle at the bottom of the image and nothing else of relevance; (2) a rear reference image includes forks of the vehicle at a bottom of the image; (3) a left reference image includes a portion of the front of the vehicle on the right and a portion of the forks at a left side of the reference image; and (4) a right reference image includes a portion of the front at a left portion of the image and a portion of the forks at a left side of the image. This example only includes four reference images, but other amounts of reference images may be used (e.g., multiple images for each orientation, orientations on another vehicle, etc.). In this example, the sensors include the reference images and configuration files in a memory and a processor with access to the memory. Moreover, in this example, there is a minimum threshold of 75% similarity to use a reference image as the orientation of the sensor.

A user mounts the sensor to the left position on the autonomous industrial vehicle and couples the sensor to the communication system of the vehicle (wired or wirelessly). The sensor then initiates the process 100 of FIG. 1 and collects at 102 a scan. The processor determines at 104 a field of view, which in this case is the entire scan. At 106, the processor on the sensor retrieves the reference images and compares the field of view to the reference images. The comparison returns the following similarity scores: (1) front reference image=20%; (2) rear reference image=15%; (3) left reference image=90%; and (4) right reference image=40%. Therefore, the processor determines that the sensor is oriented on the left position on the vehicle.

At 110, the processor determines that a configuration file associated with the left position should be used to configure the sensor. The sensor does not need information associated with other sensors mounted on the vehicle or that will be on the vehicle. Instead, the determination of the orientation and position is performed agnostically to and independently of any other sensors that may be on the vehicle. At 112, the sensor is configured with the configuration file associated with the left position and is ready for use.

### Example 2—Vehicle

As another example, assume the same vehicle, the same reference images, and the same threshold as the previous example. However, the reference images are stored on the vehicle instead of on the sensor itself.

A user mounts the sensor to the left position on the autonomous industrial vehicle and couples the sensor to the communication system of the vehicle (wired or wirelessly). However, the user accidentally mounted the sensor facing the vehicle instead of facing outward from the vehicle. The vehicle detects the sensor and initiates the process 100 of FIG. 1 and collects at 102 a scan from the sensor. A processor on the vehicle determines at 104 a field of view, which in this case is the entire scan. At 106, the processor retrieves the reference images and compares the field of view to the reference images. The comparison returns the following similarity scores: (1) front reference image=10%; (2) rear reference image=15%; (3) left reference image=10%; and (4) right reference image=20%. All of the reference images have a similarity value less than the threshold, so none are used. In some embodiments the process 100 will attempt more scans and comparisons for a predetermined number of times and will abort the process if a similarity value is never over the threshold. In many embodiments, if the similarity value is not over the threshold, an error will be reported.

However, the user notices the problem and disconnects the sensor and orients it properly on the left side. A scan is collected, and a field of view is determined. At 106, the processor on the sensor retrieves the reference images and compares the field of view to the reference images. The comparison returns the following similarity scores: (1) front reference image=20%; (2) rear reference image=15%; (3) left reference image=90%; and (4) right reference image=40%. Therefore, the processor determines that the sensor is oriented on the left position on the vehicle.

At 110, the processor determines that a configuration file associated with the left position should be used to configure the sensor. The vehicle does not need information associated with other sensors mounted on the vehicle or that will be mounted on the vehicle. Instead, the determination of the orientation and position is performed agnostically to and independently of any other sensors that may be on the vehicle. At 112, the sensor is configured with the configuration file associated with the left position and is ready for use.

The user can then disconnect the sensor and couple the sensor to the front of the vehicle. The vehicle detects the sensor and initiates the process 100 of FIG. 1 and collects at 102 a scan from the sensor. A processor on the vehicle determines at 104 a field of view, which in this case is the entire scan. At 106, the processor retrieves the reference images and compares the field of view to the reference images. The comparison returns the following similarity scores: (1) front reference image=85%; (2) rear reference image=25%; (3) left reference image=40%; and (4) right reference image=40%. Therefore, the processor determines that the sensor is oriented on the front orientation on the vehicle.

At 110, the processor determines that a configuration file associated with the front should be used to configure the sensor. The processor does not need information associated with other sensors mounted on the vehicle or that will be on the vehicle. Instead, the determination of the orientation and position is performed agnostically to and independently of any other sensors that may be on the vehicle. At 112, the sensor is configured with the configuration file associated with the front and is ready for use. Thus, the same sensor can be used at different positions/orientations on the vehicle.

In the two examples above, the reference images are stored on the same device (i.e., sensor or vehicle) as the processor used to perform the process. However, that is not required. Thus, the reference images may be stored on the sensor and the vehicle processor performs the process 100 (retrieving the reference images from the sensor) or vice-versa.

### Example 3—Remote Server

In another example, the vehicle, reference images, and threshold are the same as in the first two examples above. However, the reference images are stored on a remote server instead of the sensor or the vehicle.

A user mounts the sensor to the left position on the autonomous industrial vehicle and couples the sensor to the communication system of the vehicle (wired or wirelessly). A processor on the sensor or the vehicle initiates the process 100 of FIG. 1 and collects at 102 a scan. The processor determines at 104 a field of view, which in this case is the entire scan. In some embodiments, the processor on the vehicle or sensor then wirelessly requests and receives the reference images from the server. In other embodiments, the vehicle or sensor sends the field of view to the server.

At 106, a processor (on the server, vehicle, or sensor) compares the field of view to the reference images. The comparison returns the following similarity scores: (1) front reference image=20%; (2) rear reference image=15%; (3) left reference image=90%; and (4) right reference image=40%. Therefore, the processor determines that the sensor is oriented on the left position on the vehicle.

At 110, the processor determines that a configuration file associated with the left position should be used to configure the sensor. The processor does not need information associated with other sensors mounted on the vehicle or that will be on the vehicle. Instead, the determination of the orientation and position is performed agnostically to and independently of any other sensors that may be on the vehicle. At 112, the sensor is configured with the configuration file associated with the left position and is ready for use. In some embodiments, the configuration file is sent by the server to the vehicle or sensor.

The processing discussed in the third example may be performed by the sensor, the vehicle, the server, or combinations thereof (e.g., a portion on the vehicle, a portion on the server, and a portion on the sensor; a portion on the server and a portion on the vehicle; etc.).

As discussed above, the reference images may include an image of a portion of the vehicle that is in view from an orientation associated with the reference image. Moreover, the portion of the vehicle may also help identify not only the orientation of the sensor on the vehicle, but also which type of vehicle that the sensor is on. For example, a reference image for a front orientation on a first type of vehicle could be different than a reference image for a second type of vehicle at the same orientation. Thus, more than one reference image may be associated with an orientation. Also, more than one reference image may be associated with a vehicle-orientation.

Using the processes and sensors described herein, a sensor may be put at any orientation (as discussed above, an orientation also includes a location) on a vehicle and then be configured automatically for that orientation.

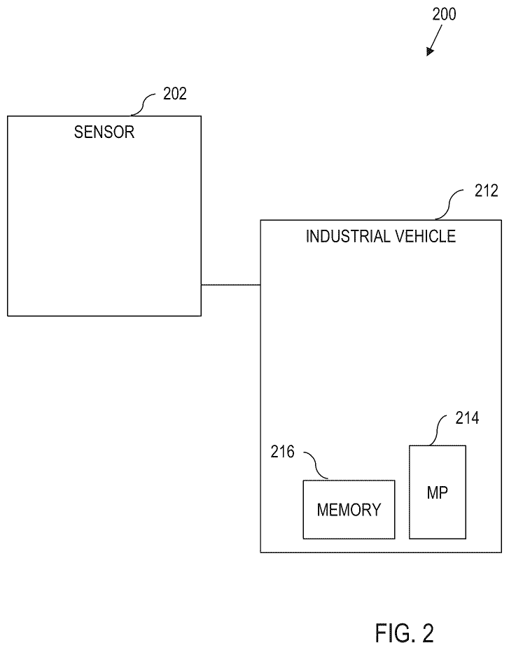

FIG. 2 is a block diagram illustrating a system 200 that includes a sensor 202 removably coupled (physically and communicatively) to an industrial vehicle 212 that includes a processor 314 and a memory 316. The system 200 of FIG. 2 includes the reference images in the memory 216 and uses the processor 214 to perform the processes described herein.

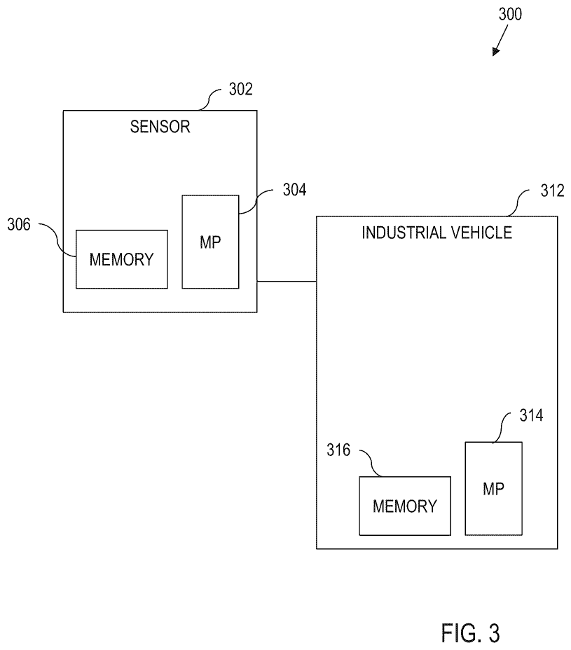

FIG. 3 is a block diagram illustrating a system 300 that includes a sensor 302 with a processor 304 and a memory 306. The sensor 302 is removably coupled (physically and communicatively) to an industrial vehicle 312 that includes a processor 314 and a memory 316. The system 300 of FIG. 3 may include the reference images in any of the memories 306, 316 and may use any of the processors 304, 314 to perform any portion of the processes described herein.

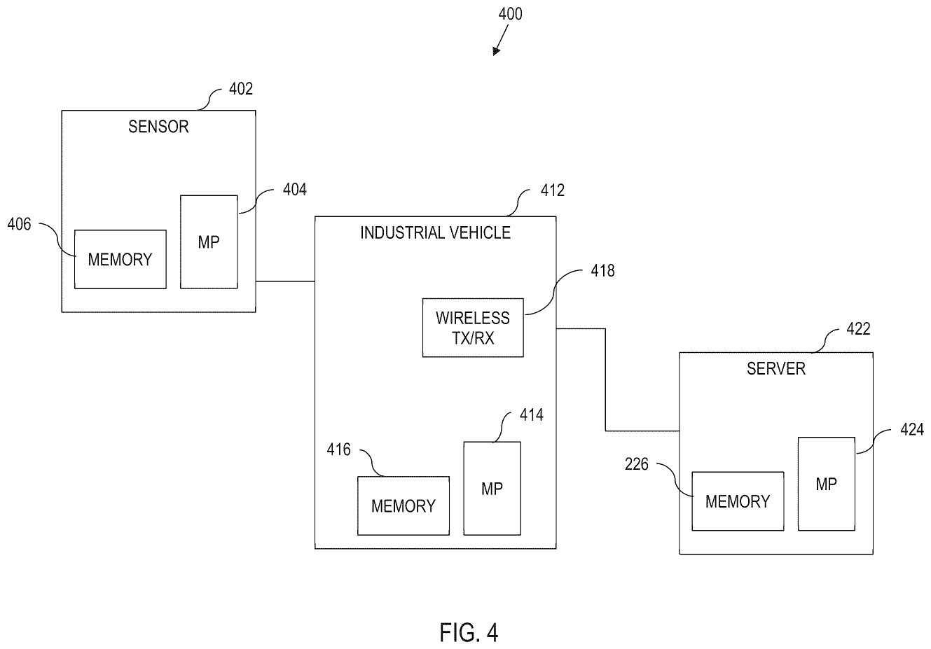

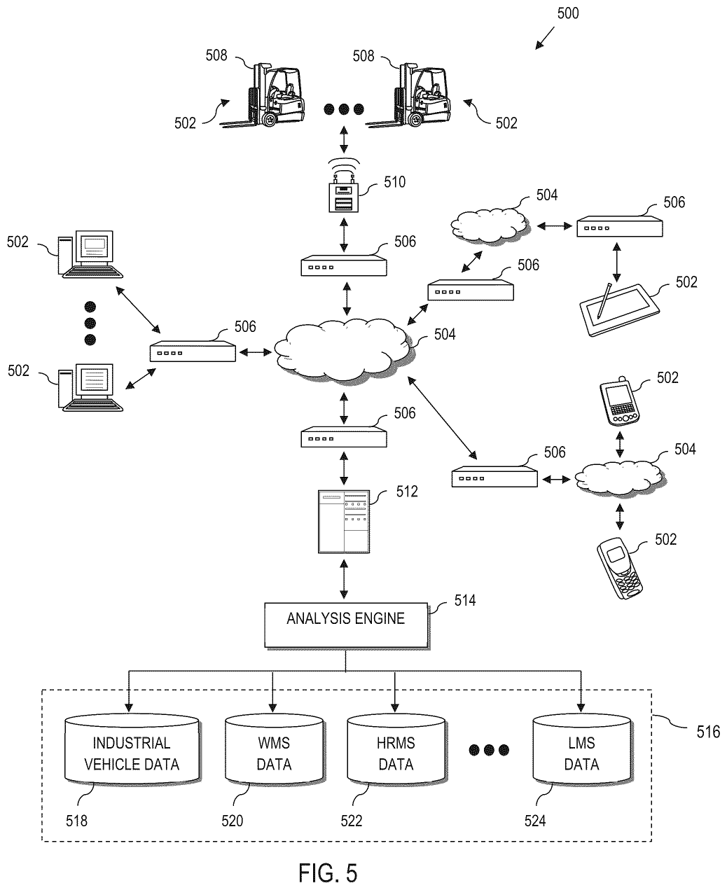

FIG. 4 is a block diagram illustrating a system 400 that includes a sensor 402 with a processor 404 and a memory 406. The sensor 402 is removably coupled (physically and communicatively) to an industrial vehicle 412 that includes a processor 414 and a memory 416. In some embodiments, the industrial vehicle 412 includes a wireless transceiver 418 for communication with a remote server 422. FIG. 5 below discusses wireless communication between devices (e.g., an industrial vehicle) and a remote server. The system 400 of FIG. 4 may include the reference images in any of the memories 406, 416, 426 and may use any of the processors 204, 214, 216 to perform any portion of the processes described herein. In some embodiments of the system 400, the sensor 402 does not include the processor 404, memory 406, or both.

Using embodiments of the processes and systems 100, 200, 300, 400 described herein, discrete reference images may be used to determine a discrete position on an industrial vehicle that a sensor is coupled to. In other words, a sensor can couple to an industrial vehicle at a predetermined number of discrete positions on the industrial vehicle, and each discrete position is associated with one or more discrete reference images for a comparison to determine which discrete position the sensor is coupled to. Then, after figuring out the position (including orientation), the sensor is configured based on its discrete position on the industrial vehicle.

Referring now to FIG. 5, a general diagram of a system 500 is illustrated according to various aspects of the present disclosure. The illustrated system 500 is a special purpose (particular) computing environment that includes a plurality of hardware processing devices (designated generally by the reference 502) that are linked together by one or more network(s) (designated generally by the reference 504).

The network(s) 504 provides communications links between the various processing devices 502 and may be supported by networking components 506 that interconnect the processing devices 502, including for example, routers, hubs, firewalls, network interfaces, wired or wireless communications links and corresponding interconnections, cellular stations and corresponding cellular conversion technologies (e.g., to convert between cellular and TCP/IP, etc.). Moreover, the network(s) 504 may comprise connections using one or more intranets, extranets, local area networks (LAN), wide area networks (WAN), wireless networks (Wi-Fi), the Internet, including the world wide web, cellular and/or other arrangements for enabling communication between the processing devices 502, in either real time or otherwise (e.g., via time shifting, batch processing, etc.).

A processing device 502 can be implemented as a server, personal computer, laptop computer, netbook computer, purpose-driven appliance, special purpose computing device and/or other device capable of communicating over the network 504. Other types of processing devices 502 include for example, personal data assistant (PDA) processors, palm computers, cellular devices including cellular mobile telephones and smart telephones, tablet computers, an electronic control unit (ECU), a display of the industrial vehicle, etc.

Still further, a processing device 502 is provided on one or more autonomous or semiautonomous industrial vehicles 508 such as a forklift truck, reach truck, stock picker, automated guided vehicle, turret truck, tow tractor, rider pallet truck, walkie stacker truck, quick pick remote truck, etc. In the example configuration illustrated, the industrial vehicles 508 wirelessly communicate through one or more access points 510 to a corresponding networking component 506, which serves as a connection to the network 504. Alternatively, the industrial vehicles 508 can be equipped with Wi-Fi, cellular or other suitable technology that allows the processing device 502 on the industrial vehicle 508 to communicate directly with a remote device (e.g., over the networks 504).

The illustrated system 100 also includes a processing device implemented as a server 512 (e.g., a web server, file server, and/or other processing device) that supports an analysis engine 514 (e.g., that may be used to perform portions of the process 100, FIG. 1) and corresponding data sources (collectively identified as data sources 516 (which may or may not include references images as described herein)). The analysis engine 514 and data sources 516 provide domain-level resources to the industrial vehicles 508. Moreover, the data sources 516 store data related to activities of the industrial vehicles 508.

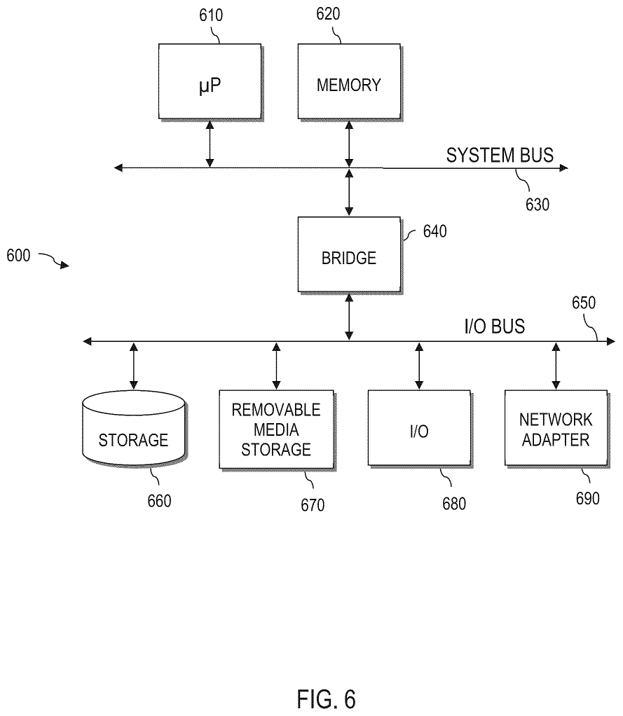

Referring to FIG. 6, a block diagram of a data processing system (i.e., computer system that may be used as a server) is depicted in accordance with embodiments. Data processing system 600 may comprise a symmetric multiprocessor (SMP) system or other configuration including a plurality of processors 610 connected to system bus 630. Alternatively, a single processor 610 may be employed. Also connected to system bus 630 is local memory 620. An I/O bus bridge 640 is connected to the system bus 930 and provides an interface to an I/O bus 650. The I/O bus may be utilized to support one or more buses and corresponding devices 670, such as storage 660, removable media storage 670, input output devices (I/O devices) 680, network adapters 690, etc. Network adapters may also be coupled to the system to enable the data processing system to become coupled to other data processing systems or remote printers or storage devices through intervening private or public networks.

Also connected to the I/O bus may be devices such as a graphics adapter, storage and a computer usable storage medium having computer usable program code embodied thereon. The computer usable program code may be executed to implement any aspect of the present embodiments, for example, to implement any aspect of any of the methods and/or system components described herein.

The disclosure describes herein numerous aspects, that characterize different features, combinations of features, capabilities, etc. In this regard, embodiments and claims herein can encompass any combination of one or more aspects in any desired combination unless the specification expressly excludes such combinations.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer storage medium does not include propagating signals.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Network using a Network Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the form disclosed. Many modifications and variations will be apparent to those of ordinary skill in the art without departing from the scope and spirit of the disclosed embodiments. Aspects of the disclosure were chosen and described in order to best explain the principles of the disclosed embodiments and the practical application, and to enable others of ordinary skill in the art to understand the various embodiments with various modifications as are suited to the particular use contemplated.

What is claimed is:

1. A process for configuring a sensor mounted to a vehicle, the process comprising:
determining an orientation of the sensor by:
collecting a scan from the sensor;
determining a field of view of the sensor based on the scan; and
deriving an orientation of the sensor on the vehicle relative to the vehicle based on the field of view;
determining a configuration for the sensor based on the orientation of the sensor with respect to the vehicle and independent of any other sensors that may be present on the vehicle; and
configuring the sensor based on the orientation of the sensor relative to the vehicle.

2. The process of claim 1, wherein deriving the orientation of the sensor on the vehicle relative to the vehicle based on the field of view comprises:
comparing the field of view to images stored on the vehicle; and
deriving the orientation of the sensor on the vehicle based on the comparison.

3. The process of claim 2, wherein comparing the field of view to images stored on the vehicle comprises determining which image of the images stored on the vehicle has a highest number of similarities to the field of view.

4. The process of claim 3, wherein deriving the orientation of the sensor on the vehicle based on the comparison comprises matching an orientation to the image of the images stored on the vehicle that has the highest number of similarities.

5. The process of claim 4, wherein determining a configuration for the sensor comprises determining the configuration of the sensor if the highest number of similarities surpasses a threshold.

6. The process of claim 4, wherein determining a configuration for the sensor comprises determining the configuration for the sensor using a processor on the vehicle.

7. The process of claim 4, wherein determining a configuration for the sensor comprises determining the configuration for the sensor using a processor on a server.

8. The process of claim 1, wherein deriving the orientation of the sensor on the vehicle relative to the vehicle based on the field of view comprises:
sending the field of view to a server, where the server includes images of fields of view; and
receiving the orientation of the sensor from the server.

9. The process of claim 1, wherein deriving the orientation of the sensor on the vehicle relative to the vehicle based on the field of view comprises:
comparing the field of view to images stored on the vehicle; and
deriving the orientation of the sensor on the vehicle based on the comparison.

10. The process of claim 9, wherein comparing the field of view to images stored on the vehicle comprises determining which image of the images stored on the vehicle has a highest number of similarities to the field of view.

11. The process of claim 10, wherein deriving the orientation of the sensor on the vehicle based on the comparison comprises matching an orientation to the image of the images stored on the vehicle that has the highest number of similarities.

12. The process of claim 11, wherein determining a configuration for the sensor comprises determining the configuration of the sensor if the highest number of similarities surpasses a threshold.

13. The process of claim 11, wherein determining a configuration for the sensor comprises determining the configuration for the sensor using a processor on the vehicle.

14. The process of claim 11, wherein determining a configuration for the sensor comprises determining the configuration for the sensor using a processor on a server.

15. The process of claim 1, wherein deriving the orientation of the sensor on the vehicle relative to the vehicle based on the field of view comprises:
comparing the field of view to images stored on the vehicle; and
deriving the orientation of the sensor on the vehicle based on the comparison.

16. The process of claim 15, wherein comparing the field of view to images stored on the vehicle comprises determining which image of the images stored on the vehicle has a highest number of similarities to the field of view.

17. The process of claim 16, wherein deriving the orientation of the sensor on the vehicle based on the comparison comprises matching an orientation to the image of the images stored on the vehicle that has the highest number of similarities.

18. The process of claim 17, wherein determining a configuration for the sensor comprises determining the configuration of the sensor if the highest number of similarities surpasses a threshold.

19. The process of claim 17, wherein determining a configuration for the sensor comprises determining the configuration for the sensor using a processor on the vehicle.

20. The process of claim 17, wherein determining a configuration for the sensor comprises determining the configuration for the sensor using a processor on a server.
